(19) United States
(12) Patent Application Publication
(10) Pub. No.: US 2009/0151698 A1
(43) Pub. Date: Jun. 18, 2009

(54) System and Method for Providing an Air/Fuel Mixture for an Internal-Combustion Engine

(75) Inventors: Simon ELLGAS, Muenchen (DE); Alexander KROHMER, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/391,627

(22) Filed: Feb. 24, 2009

Related U.S. Application Data
(63) Continuation of application No. PCT/EP2007/006545, filed on Jul. 24, 2007.

(30) Foreign Application Priority Data
Aug. 25, 2006 (DE) 10 2006 039 973.0

(51) Int. Cl. F02B 13/10; F02G 5/02

(52) U.S. Cl. 123/445; 123/545; 123/575

(57) ABSTRACT

An air/fuel mixture consisting of air and a cryogenic fuel, particularly cryogenic hydrogen, is provided for an internal-combustion engine having at least one intake port that can be loaded with air and at least one injector that is assigned to the intake port. A nozzle for blowing in the cryogenic fuel is heatable at least in areas.

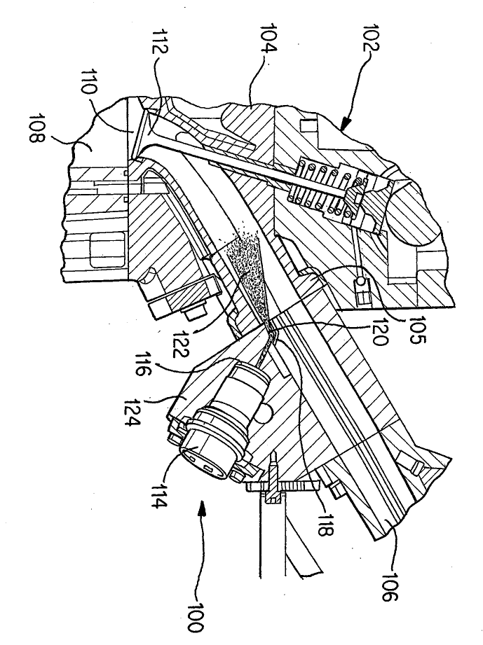

### CROSS REFERENCE TO RELATED APPLICATIONS

This application is a continuation of PCT International Application No. PCT/EP2007/006545, filed Jul. 24, 2007, which claims priority under 35 U.S.C. § 119 to German Patent Application No. DE 10 2006 039 973.0, filed Aug. 25, 2006, the entire disclosures of which are herein expressly incorporated by reference.

### BACKGROUND AND SUMMARY OF THE INVENTION

The invention relates to a system and a method for providing an air/fuel mixture consisting of air and of a cryogenic fuel, particularly cryogenic hydrogen, for an internal-combustion engine. The engine has at least one intake port that can be acted upon by air and at least one injector that is assigned to the intake port and has a nozzle for blowing in the cryogenic fuel.

In the case of internal-combustion engines, which are run by a cryogenic fuel, such as cryogenic hydrogen, the cryogenic fuel is normally fed by way of an injector, as indicated, for example, in German patent document DE 100 60 786 A1. Here, the problem arises that, as a result of the blowing-in of the cryogenic fuel, the nozzle of the injector cools below the freezing point of water. Water vapor from the intake air is deposited in the form of frost on the cold surface. The ice accumulation limits the operation of the internal-combustion engine, which may lead to a complete freezing-over of the injector and, thereby, to a failure of the internal-combustion engine.

In addition, as a result of the installation of the injector perpendicular to the intake port, the cryogenic fuel impinges on the side of the intake port situated opposite the injector. As a result of this intensive contact with the cold fuel, this surface is cooled below the freezing point of water, so that ice also accumulates here. This ice layer results in an impairment of the intake cross-section.

Furthermore, on its path from the mixture formation area to the combustion chamber of the internal-combustion engine, the cold air/fuel mixture flows through areas of the internal-combustion engine that run hot (cylinder head). Because of the large temperature difference between the intake port wall and the air/fuel mixture, an undesirable heating of the air/fuel mixture will occur which, at least partially, destroys the positive effect of the cryogenic mixture formation because a warmer mixture causes poorer air consumption and increases the knock tendency of the internal-combustion engine.

In order to counteract the described problem, according to German patent document DE 100 60 786 A1, the intake air is cooled in several stages, is dehumidified before the cooling to a final temperature level, and the cryogenic fuel is only fed to the intake air after the intake air was dehumidified. Although an icing-over of the injector nozzle with respect to the intake port can be prevented in this manner, considerable expenditures are required for this purpose.

It is therefore an object of the invention to further develop a system and method of the above-mentioned type so that an icing-over of the injector nozzle and/or of the intake port can be prevented in a simplified manner, while maintaining the advantages of the cryogenic mixture formation.

This object is achieved by a system and method according to the invention, wherein the nozzle can be heated at least in regions or areas. In this manner, particularly in those regions or areas of the injector and of the intake port, respectively, which are at risk of being iced over, a depositing of air moisture is effectively prevented; simultaneously, when heating takes place only in defined regions or areas, a feeding of heat into the cold fuel is kept to a minimum. The invention therefore makes it possible to utilize the advantages of the cryogenic mixture formation with respect to the operation of the internal-combustion engine concerning the output, the emission and the efficiency, and simultaneously avoids an icing-over in the mixture formation area. In this case, the implementation of the invention requires only low expenditures.

Particularly advantageous embodiments and further developments are described herein.

Preferably, contact between the cryogenic fuel and the heated nozzle areas can be limited with respect to time and location. As a result, excessive heating of the cold fuel can be avoided. Excessive heating is also avoided by measures for the thermal uncoupling of the fuel feed from the heatable nozzle.

According to a preferred embodiment of the invention, the waste heat of the internal-combustion engine can be utilized for passively heating the nozzle. Thus, heating can take place in a particularly simple manner and the internal-combustion engine can be cooled simultaneously without the need for a separate active heating device.

According to a further embodiment of the invention, a guide device for targeted spraying of the cryogenic fuel is provided in the intake port. This—if necessary, in connection with an arrangement of the injector diagonally with respect to the longitudinal axis of the intake port—permits a targeted spraying of the cryogenic fuel in the intake port so that the cold fuel spray is insulated by an air jacket from the warmer intake port wall or the warm cylinder head, and a feeding of heat into the fuel is minimized.

In the case of a method according to the invention, it is particularly preferable that, for avoiding excessive heating, the cryogenic fuel is only brought into contact with part of the heated area of the nozzle and/or is guided past heated regions or areas of the nozzle at a high velocity flow. Waste heat of the internal-combustion engine is expediently utilized for the passive heating of the nozzle. In addition or as an alternative, for minimizing the heat feed, the cryogenic fuel spray in the intake port is at least in areas guided centrally by way of an air jacket in an insulated manner with respect to the internal-combustion engine.

Other objects, advantages and novel features of the present invention will become apparent from the following detailed description of one or more preferred embodiments when considered in conjunction with the accompanying drawing.

### BRIEF DESCRIPTION OF THE DRAWING

The single figure illustrates a system for providing an air/fuel mixture consisting of air and cryogenic hydrogen according to the invention.

### DETAILED DESCRIPTION OF THE DRAWING

The figure is a cutout view of an internal-combustion engine 102 having a combustion chamber 108 and a cylinder head 104. The combustion chamber 108 has an intake 110, which can be closed by a valve 112. By way of the intake 110, the combustion chamber 108 of the internal-combustion engine 102 can be filled with a combustible air/fuel mixture during operation of the internal-combustion engine 102. For this purpose, an intake port 106 is assigned to the intake 110 and, on its outlet side, leads into the combustion chamber 108. On the inlet side, the intake port 106 can be loaded with air.

For blowing fuel into the inlet air flow, an injector 114 is provided, which includes a nozzle 116 on its outlet side. The injector 114 is arranged in an inclined manner with respect to the longitudinal axis of the intake port 106, so that the nozzle 116 is arranged close to a flange 105 of the cylinder head 104, which is hot during the operation, without any reduction in the average distance between the operationally cold injector 114 and the operationally hot cylinder head 104, in comparison to conventional arrangement.

The injector 114 is mounted in a cryogenic mixture formation unit 124. The cryogenic mixture formation unit 124 is made of a heat-insulating material in order to minimize the transfer of heat into the injector 114.

A deflector 118, which is thermally coupled with the cylinder head 104, is arranged in the intake port 106 and is, therefore, acted upon by heat when the internal-combustion engine 102 is operating. The deflector 118 is thermally insulated with respect to the fuel feed. The deflector 118 consists of a good heat-conducting material, such as aluminum, and is mounted on the inside wall of the intake port 106 around the nozzle 116 of the injector 114. The deflector 118 forms a nozzle oriented in the flow direction of the inlet air flow.

Cryogenic hydrogen, which is stored in the vehicle in a liquid state, is applied under pressure to the injector 114 by way of a feed pipe. During the operation of the internal-combustion engine 102, for filling the combustion engine chamber 108, when the valve 112 is open, the injector 114 opens up, actuated by way of a control device, so that a predefined fuel flow volume exits by way of the nozzle 116. The cold fuel flow 120 impinges upon the deflector 118 thermally connected with the warm cylinder head 104. As a result, a cooling below the freezing point of water is avoided, and an accumulation of moisture from the air flowing in through the intake port 106 in the form of frost or ice is effectively prevented.

In a radially expanding manner, the fuel spray 122 flows from the deflector 118 in the flow direction of the inlet air flow. In this case, particularly close to the nozzle, the fuel spray 122 is guided such that an air layer remains between the fuel spray 122 and the intake port wall, which air layer provides insulation with respect to the intake port wall. As a result, moisture accumulation from the air flowing in through the intake port 106 in the form of frost or ice on the intake port wall is effectively prevented. The fuel flow fans out downstream, mixes with air, and heats up.

The deflector 118 thus allows for the cold fuel to be heated, as well as for heat to be removed from the cylinder head, on the one hand; on the other hand, the fuel flow is thereby blown centrally, while being insulated at least in areas via an air jacket with respect to the intake port wall, into the inlet air flow.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for providing an air/fuel mixture comprising air and a cryogenic fuel, the system comprising:
an internal-combustion engine comprising at least one intake port and at least one fuel injector assigned to the intake port;
wherein the fuel injector has a nozzle for blowing the cryogenic fuel into the intake port, the intake port being loadable with air; and
a heater for heating, at least in one region, the nozzle for blowing in the cryogenic fuel.

2. The system according to claim 1, wherein contact between the cryogenic fuel and the heated nozzle region is limitable based on time and location.

3. The system according to claim 1, further comprising means for thermally uncoupling the fuel feed from the heatable nozzle.

4. The system according to claim 1, wherein waste heat of the internal-combustion engine passively heats the nozzle at least in the one region.

5. The system according to claim 1, further comprising a guide device operatively arranged in the intake port for a targeted spraying of the cryogenic fuel.

6. The system according to claim 2, further comprising a guide device operatively arranged in the intake port for a targeted spraying of the cryogenic fuel.

7. The system according to claim 3, further comprising a guide device operatively arranged in the intake port for a targeted spraying of the cryogenic fuel.

8. The system according to claim 4, further comprising a guide device operatively arranged in the intake port for a targeted spraying of the cryogenic fuel.

9. The system according to claim 1, wherein the fuel injector is arranged diagonally with respect to a longitudinal axis of the intake port.

10. The system according to claim 2, wherein the fuel injector is arranged diagonally with respect to a longitudinal axis of the intake port.

11. The system according to claim 5, wherein the fuel injector is arranged diagonally with respect to a longitudinal axis of the intake port.

12. The system according to claim 1, wherein the cryogenic fuel is hydrogen.

13. A method of operating an internal-combustion engine having at least one intake port loadable with air and at least one injector having a nozzle assigned to the intake port, the method comprising the acts of:
blowing in a cryogenic fuel for an air/fuel mixture into the intake port via the nozzle;
heating, at least in one region, the nozzle for blowing in the cryogenic fuel; and
providing the air/fuel mixture to a combustion chamber of the internal-combustion engine.

14. The method according to claim 13, wherein, for avoiding excessive heating of the cryogenic fuel, the cryogenic fuel is brought into contact with only a part of the heated region of the nozzle and/or is guided past the heated region of the nozzle at a high velocity flow.

15. The method according to claim 13, further comprising the act of passively heating said at least one region of the nozzle using waste heat of the internal-combustion engine.

16. The method according to claim 14, further comprising the act of passively heating said at least one region of the nozzle using waste heat of the internal-combustion engine.

17. The method according to claim 13, wherein, for minimizing heat feed, the cryogenic fuel spray is guided in the intake port at least in areas centrally so as to be insulated via an air jacket with respect to the internal-combustion engine.

18. An internal-combustion engine operated by an air/fuel mixture comprising air and a cryogenic fuel, the internal-combustion engine comprising:
at least one intake port having an inlet side and an outlet side, the outlet side leading into a combustion chamber of the internal-combustion engine;
an injector having an injector nozzle, the injector being operatively arranged to inject the cryogenic fuel into the intake port; and
a heating system operatively configured to heat the nozzle of the injector in one or more defined regions, whereby the cryogenic fuel is heated to minimize ice formation in a mixture formation area of the cryogenic fuel and air in the intake port.

19. The internal-combustion engine according to claim 18, wherein the heating system comprises a passive heater utilizing waste heat of the internal-combustion engine to heat the nozzle.

20. The internal-combustion engine according to claim 18, further comprising:
a deflector arranged in the intake port and thermally coupled with a cylinder head of the internal-combustion engine, the deflector being thermally insulated with respect to the fuel feed;
wherein the cryogenic fuel from the nozzle impinges upon the deflector, which functions to heat the cryogenic fuel above a freezing point of water to substantially prevent ice accumulation due to the air flow in the intake port.
